(19) United States
(12) Patent Application Publication
(10) Pub. No.: US 2006/0162775 A1
(43) Pub. Date: Jul. 27, 2006

(54) Valve assembly

(76) Inventor: Patrick Drayer, Capistrano Beach, CA (US)

Correspondence Address: W. Eric Boyd, Esq., 39 Albergar, San Clemente, CA, 92672, US

(21) Appl. No.: 11/045,033

(22) Filed: Jan. 27, 2005

(51) Int. Cl. F16K 24/04

(52) U.S. Cl. 137/202

(57) ABSTRACT

A valve assembly for purging a gas from a conduit system is disclosed. The valve assembly is comprised of a housing defining an interior volume. The housing additionally comprises an inlet port and an outlet port in fluid communication with the interior volume. A buoyant valve member is provided within the interior volume and is adapted to seal the outlet port as the interior volume fills with a fluid such as water. The input port is sealably affixed on a riser such that fluid flow from the riser is directed into the interior volume of the housing. Air entering the interior volume is directed around the valve member and exits the housing through the outlet port. As the air is purged from the system, fluid, such as water, enters the interior volume, causing the valve member to rise. As water reaches the outlet port, the valve member forms a watertight seal, preventing water flow out of the outlet port.

### BACKGROUND OF THE INVENTION

1. Field of the Invention

The invention relates generally to the field of plumbing. Specifically, the invention relates to a simple and cost-effective device and method for purging air from a plumbing or piping system utilizing a valve assembly which seals one or more risers in a system when a fluid, typically water, reaches a predetermined level. The invention also claims the valve assembly in cooperation with an elastic sealing cap adaptable for risers of varying inner and outer diameters.

2. Description of the Background Art

The field of plumbing involves a large number of individual processes relating to the assembly and testing of new and existing piping conduit systems. Such systems include pressurized fresh water systems, drainage systems or waste/sewer systems found in new residential and commercial construction.

A typical plumbing application is the in-ground installation of new sewer lines, also referred to as soil or waste lines, for interconnection to existing main sewer lines or septic systems. The steps involved in a common sewer line installation are the ground trenching, installation and assembly of multiple pipe segments, usually according to an engineered set of drawings.

Multiple upwardly depending risers, comprising pipe segments that are open and terminate in the atmosphere above ground level, are assembled and terminated at predetermined locations where they will ultimately be fitted with appropriate plumbing connections for final assembly to various pluming fixtures such as toilet outlets and sink and bath drainage connections.

Prior to final connection of the newly installed conduit system with the main sewer and plumbing fixtures, best practices require that new conduit systems be filled with water and substantially purged of all air. It is not uncommon that a municipal plumbing inspector requests or expects the plumbing installation contractor will demonstrate that the conduit system is purged of air.

Heretofore, common methods used to purge air in a conduit system have included filling an input riser in a conduit system with water, such that a known head pressure, e.g., two feet, is induced into the system. The vertical discharge “head pressure” may be defined as the vertical lift in height (usually measured in feet of water) at which the water supplied to the input riser can no longer exert enough pressure to move water out of the remaining risers.

The water that is input into the riser is communicated into the conduit system such that it may be stated that the conduit system has a given number of feet of head pressure.

In a prior art method of purging air from a conduit system, the user merely fills the input riser until only water flows out of each riser at which point, each riser is capped. This has the obvious result of excess water flow at the riser termination point and is inefficient and labor intensive.

In an alternative prior art method, each riser is capped, the input riser is filled with water and the user briefly uncaps each riser until water flows out of it. This method retains the negative features of the method discussed above.

In yet another alternative prior art method, a rubber or plastic seal is affixed to each riser and water is input into the conduit system. The user then inserts a nail or other sharp object into the seal to release trapped air in the riser. When the air has been evacuated from the riser and water begins to flow from the riser, the user inserts the nail back into the hole in the seal to stop the flow. This method again has the undesirable result of allowing water out of the conduit system at the termination point, is labor intensive and risks the sealed hole leaking additional water at the termination site.

What is needed is a device and method that provide a simple, cost-effective and reliable means for purging air from a conduit system that overcomes the aforementioned prior art limitations and that minimizes or eliminates the flow of a fluid from a riser in a conduit system at an installation location. Further, a device is needed that may be used in cooperation with existing plumbing parts and existing plumbing standards and which is easily affixable and removable from a riser.

### SUMMARY OF THE INVENTION

The present invention discloses a valve assembly comprised of a housing defining an interior volume. The housing additionally comprises an inlet port and an outlet port in fluid communication with the interior volume. A buoyant valve member is provided within the interior volume and is adapted to seal the outlet port as the interior volume fills with a fluid such as water. The housing is sealably affixed on a riser such that fluid flow from the riser is directed into the interior volume of the housing via the input port.

Air entering the interior volume as the conduit system fills with water is directed around the valve member and exits the housing through the outlet port. As the air is purged from the system, fluid, such as water, ultimately enters the interior volume, causing the valve member to rise. As water reaches the outlet port, the valve member forms a watertight seal, preventing water flow out of the outlet port. This and additional preferred embodiments of the invention are described herein.

It should be noted that, while the claimed apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112, are to be accorded full statutory equivalents under 35 USC 112.

### BRIEF DESCRIPTION OF THE DRAWINGS

FIG. 1 is a schematic view of a conduit system showing an input riser and multiple risers terminating above ground with the conduit system having water and air entrapped therein.

FIG. 2 is a schematic view of a conduit system showing the valve assembly of the invention installed on the above-ground termination portions of the risers.

FIGS. 3a, 3b and 3c are a perspective view, top view and cross-sectional view respectively, of the valve assembly of the invention.

FIG. 4 is a further cross-sectional view of the invention and illustrating the threaded separable housing embodiment.

The invention and its various embodiments can now be better understood by turning to the following description of the preferred embodiments which are presented as illustrated examples of the invention defined in the claims.

The foregoing and other features, aspects and advantages of the present invention will become more apparent from the following description of the present invention when taken in conjunction with the accompanying drawings. It is expressly understood that the invention as defined by the claims may be broader than the illustrated embodiments described below.

### DESCRIPTION OF THE PREFERRED EMBODIMENTS

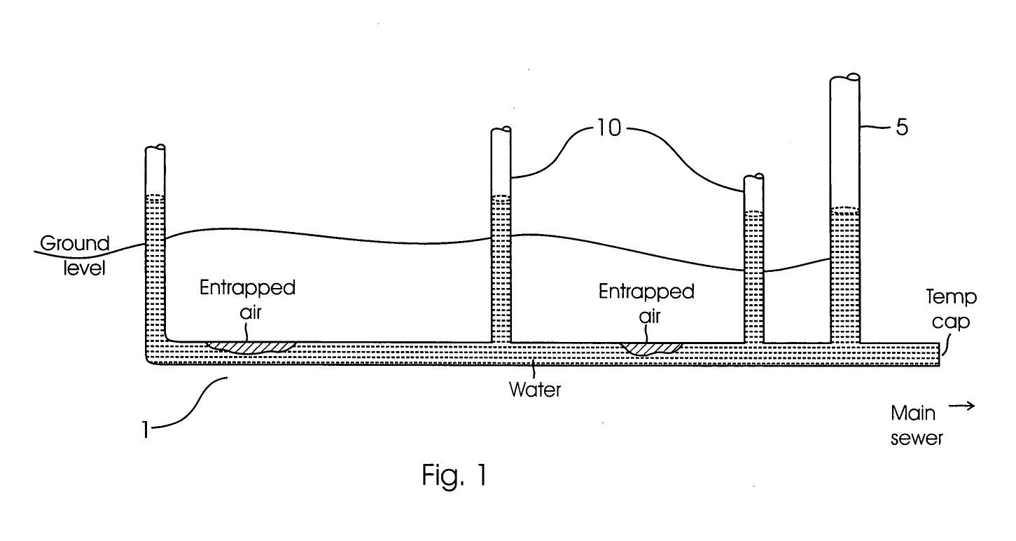

Turning now to the figures wherein like numerals identify like elements among the several views, FIG. 1 shows an exemplar conduit system 1 as may typically be found in a new installation of a waste line. It is noted that the invention as claimed is not limited to use on waste lines but may have beneficial application to any conduit system, such as fresh water lines, medical, automotive, machine, industrial, or manufacturing applications or situations where an enclosed conduit system contains entrapped air which must be purged.

Conduit system 1 comprises an input riser 5, which riser is typically terminated at a point higher than the termination of risers 10. In a common application, input riser 5 terminates at a point in the atmosphere two or more feet above the lowermost termination point of the remaining risers 10 such that, when input riser 5 is filled with water, two vertical feet of head pressure are induced into conduit system 1.

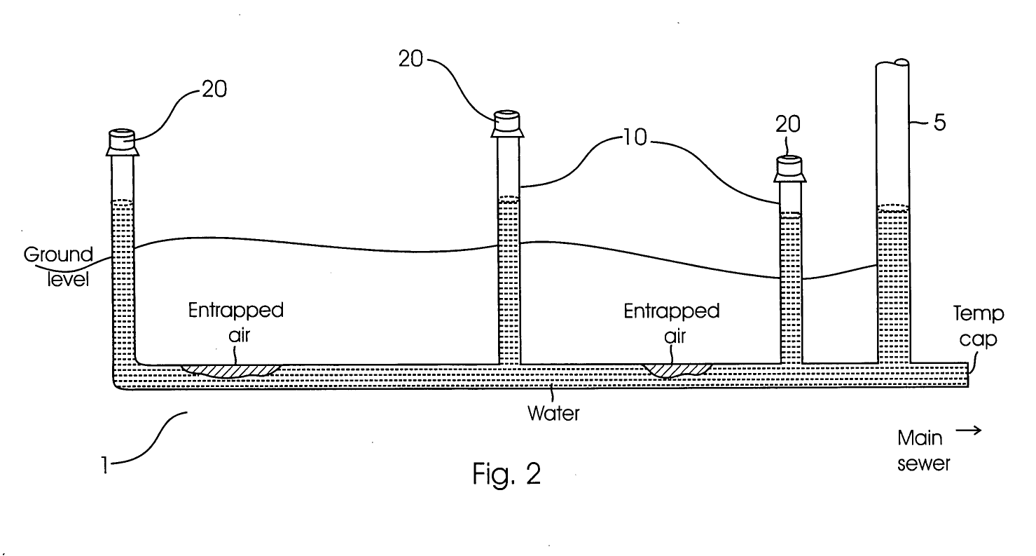

FIG. 2 illustrates the valve assembly 20 of the invention installed on the above-ground, terminating portion of risers 10 whereby entrapped air in the conduit system may be efficiently purged therefrom.

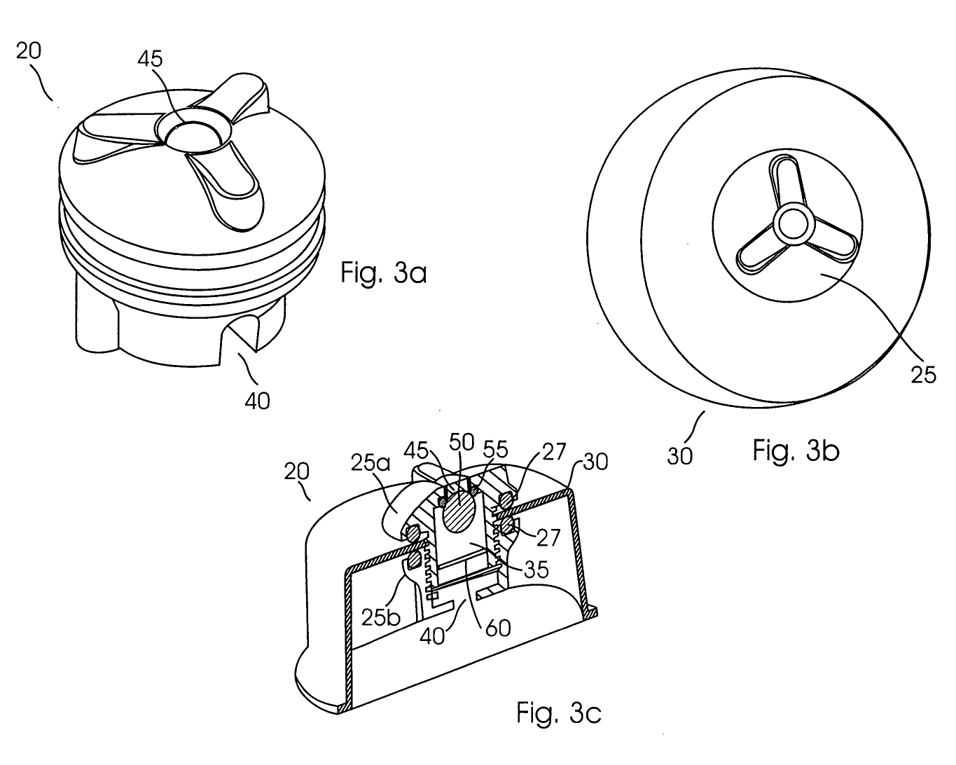

Turning now to FIGS. 3a, 3b and 3c, a preferred embodiment of valve assembly 20 is shown.

FIGS. 3a and 3c show a housing 25 comprised of a threaded upper portion 25a and lower portion 25b which are assembled to comprise housing 25. FIGS. 3b and 3c illustrate valve assembly 20 assembled in cooperation with a pipe end cap 30 as is commercially available from Mission Rubber Co. Inc. Pipe end cap 30 is available to fit commonly manufactured pipe outer diameters. It is expressly noted that valve assembly 20 of the invention is not limited to assembly with a pipe end cap but may be manufactured so that the sealing function of pipe end cap 30 is integral with housing 25.

In a preferred embodiment of valve assembly 20, each of upper housing 25a and lower housing 25b are provided with one or more gaskets or O-rings 27 on their respective mating surfaces whereby, when the respective upper housing 25a and lower housing 25b are threadedly assembled upon and through pipe end cap 30, a fluid-tight seal is created about the outer circumference of housing 25.

Housing 25 defines an interior volume 35 and further comprises an inlet port 40 and an outlet port 45. Inlet port 40 and outlet port 45 are each in fluid communication with interior volume 35.

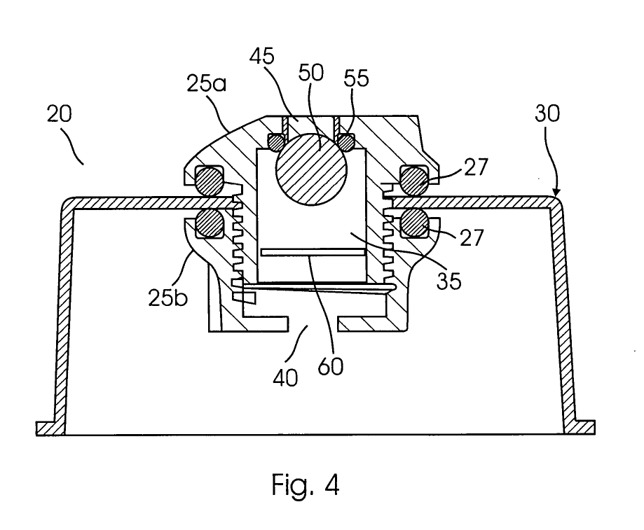

As is seen in FIGS. 3c and 4, a valve member 50 is movabley disposed and confined within interior volume 35 whereby valve member 50 may readily float in a fluid contained within interior volume 35. Valve member 50 is preferably spherical is shape and made from a durable, material that is buoyant relative to the fluid within the conduit system such as, in the case of water, a polyethylene plastic. Further, valve member 50 preferably has an outer diameter with respect to the diameter of interior volume 35 whereby air may readily flow around and past valve member 50 and through outlet port 45.

In the preferred embodiment, interior volume 35 further comprises outlet port seal 55 for sealably receiving valve member 50.

Outlet port seal 55 is desirably an annular gasket or O-ring made from an resilient, elastomeric material such as rubber or plastic. The diameter of the opening defined by outlet port seal 55 is such that valve member 50 is sealably received within and upon it to prevent fluid flow from interior volume 35 through outlet port 45 in the event valve member 50 rises in a fluid contained within interior volume 35. In this manner, valve member 50 will rise and fall within interior volume 35 as a fluid fills or drains therefrom and will form a fluid seal with outlet port seal 55 when interior volume 35 is substantially filled with a fluid.

Retaining member 60 is preferably provided to confine valve member 50 within interior volume 35. Alternatively, inlet port 40 may be defined in a manner whereby valve member 50 is confined within interior volume 35.

In an alternative preferred embodiment, housing 25 comprises and is integral with pipe end cap 30 for sealaby connecting valve assembly 20 to a pipe end.

A hose clamp (not shown) or equivalent device may be used to enhance the seal between pipe end cap 30 and the pipe end to which it is affixed.

The use of valve device 20 to purge air from a conduit system is illustrated in FIG. 2 which shows valve device 20 of the present invention sealaby affixed to multiple risers 10. Pipe end cap 30 is assembled over the outer diameter of the terminal, above-ground portion of riser 10, the inner diameter of pipe end cap 30 preferably being substantially that of the outer diameter of selected riser 10. A fluid-tight seal should be achieved, such as by use of a hose clamp or other compression means.

When risers 10 are fitted with valve devices 20, water is introduced into conduit system 1 through input riser 4 whereby a predetermined head pressure is introduced into the system. As the water is introduced and the head pressure overcomes that necessary to cause water to flow from risers 10, entrapped air in conduit system escapes each of risers 10 through inlet port 40, past and around valve member 50 and to the atmosphere through outlet port 45. As the head pressure in conduit system 1 increases and air exits risers 10, water in the system enters risers 10 and the water level in risers 10 rises toward valve device 20.

Water in riser 10 enters valve device 20 through inlet port 40 into interior volume 35. As the water level in interior volume 35 increases, valve member 50 will float approximately at the surface level of the water therewithin. As the water surface level within interior volume 35 rises toward outlet port 45 which is open to the atmosphere and outlet port seal 55, valve member 50 is received upon and within outlet port seal 55, producing a fluid seal.

The resultant seal prohibits the flow of water through outlet port 45. This in turn, increases water pressure on valve member 50, whereby a compression seal is produced upon outlet port seal 55.

As compression seals are formed on the various outlet port seals within each of valve devices 20 on risers 10, a fluid seal is produced and water will cease flow through risers 10. No labor is required during the purging process other than the creation of fluid head pressure within the system.

Upon satisfactory inspection, valve devices 20 are removed from risers 10 for use at another installation.

As can be readily seen, the valve device of the present invention provides an efficient, low cost and simple means of purging air or gas from a conduit system and minimizes fluid flow out of risers on to an installation site.

Many alterations and modifications may be made by those having ordinary skill in the art without departing from the spirit and scope of the invention. Therefore, it must be understood that the illustrated embodiment has been set forth only for the purpose of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed even when not initially claimed in such combinations.

The words used in this specification to describe the invention and its various embodiments are to be understood not only in the sense of their commonly defined meanings, but to include by special definition in this specification, structure, material or acts beyond the scope of the commonly defined meanings. Thus, if an element can be understood in the context of this specification as including more than one meaning, then its use in a claim must be understood as being generic to all possible meanings supported by the specification and by the word itself.

The definitions of the words or elements of the following claims are therefore defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what essentially incorporates the essential idea of the invention.

1. A valve assembly for purging air from a conduit comprised of:
a housing defining an interior volume and further defining an inlet port and an outlet port;
said inlet port and said outlet port in fluid communication with said interior volume;
a valve member moveably disposed within said interior volume;
said outlet port adapted with means for sealably receiving said valve member;
said inlet port adapted with means for sealably receiving a fluid flow from a conduit,
said housing disposed integral with and through an elastic pipe end cap;
said elastic pipe end cap adapted to be removably affixed to a pipe end to form a seal between said elastic pipe end cap and said pipe end whereby said inlet port may be selectively put in fluid communication with the interior of a pipe.

2. The valve assembly of claim 1 wherein said valve member is comprised of a buoyant material relative to water.

3. The valve assembly of claim 1 wherein said valve member is comprised of a polyethylene material.

4. The valve assembly of claim 1 wherein said valve member is spherical.

5. The valve assembly of claim 1 wherein said interior volume of said further comprises an outlet port seal circumscribing said outlet port.

6. The valve assembly of claim 1 wherein said valve member is moveably retained with said interior volume by a retaining member.

7. The valve assembly of claim 1 wherein said retaining member is a retaining pin.

8. (canceled)

9. (canceled)

10. The valve assembly of claim 1 wherein said housing is selectively separable into an upper portion and a lower portion by means of threads.

11. The valve assembly of claim 5 wherein said outlet port seal is an elastomeric gasket.

12. The valve assembly of claim 5 wherein said outlet port seal is annular.
